(19) United States
(12) Patent Application Publication
(10) Pub. No.: US 2013/0303175 A1
(43) Pub. Date: Nov. 14, 2013

(54) HANDOVER CONTROL METHOD, MOBILE STATION DEVICE, AND BASE STATION DEVICE

(71) Applicant: Akio Yoshihara, Osaka-shi (JP)

(72) Inventor: Akio Yoshihara, Osaka-shi (JP)

(73) Assignee: SHARP KABUSHIKI KAISHA, Osaka-shi, Osaka (JP)

(21) Appl. No.: 13/983,009

(22) PCT Filed: Feb. 3, 2012
(86) PCT No.: PCT/JP2012/052484

§ 371 Date: Jul. 31, 2013

(30) Foreign Application Priority Data
Feb. 3, 2011 (JP) 2011-021295

(51) Int. Cl. H04W 36/00

(52) U.S. Cl. CPC H04W 36/0061
USPC 455/443

(57) ABSTRACT

In a handover control method of a mobile station device, it is determined that whether or not the mobile station device is within the CSG cell. In addition, it is determined that whether or not the CSG cell is an HPLMN, in case that it is determined that the mobile station device is within the CSG cell. In addition, a neighboring cell measurement is executed and handover is performed, in case that it is determined that the CSG cell is the HPLMN, and in case that the mobile station device is set to measure the neighboring cell. In addition, the neighboring cell is not measured, in case that it is determined that the CSG cell is not the HPLMN, and even in case that the mobile station device is set to measure the neighboring cell.

### TECHNICAL FIELD

The present invention relates to a handover control method, a mobile station device, and a base station device in a wireless communication system that includes a home cell.

The subject application claims priority based on the patent application No. 2011-021295 filed in Japan on Feb. 3, 2011 and incorporates by reference herein the content thereof.

### BACKGROUND ART

In the W-CDMA (Wideband Code Division Multiple Access), LTE (Long-Term Evolution), and LTE-A (LTE-Advanced) mobile communication standards, macrocells having conventional wide-ranging service areas are proposed. In addition, in W-CDMA, LTE, and LTE-A, home cells (Home NodeB or Home eNodeB, small base stations), which provide service over a narrow range or service with respect to a specific user have been proposed. In 3GPP E-UTRA (The 3rd Generation Partnership Project Evolved Universal Terrestrial Radio Access) as well, study is proceeding with regard to operation of home cells.

Types of cells provided by home cells in 3GPP E-UTRA are normal cells, CSG (Closed Subscriber Group) cells, and hybrid cells. A normal cell is a cell to which any user can connect. A CSG cell is a cell that permits the connection to only a specific user. A hybrid cell can be connected to as a CSG cell by some users (mobile station devices), and connected to as a normal cell by other users.

Specifications for these types of home cells are defined as access control and manual CSG cell selection in Chapter 6 and Chapter 7 of Non-Patent Reference 1. In Non-Patent Reference 2, an investigation is proposed of whether or not, in the state such as shown in FIG. 9, it is necessary to limit handover from a CSG cell to a macrocell. FIG. 9 will now be described. In FIG. 9, two Public Land Mobile Networks (PLMNs) are formed. FIG. 9 shows the state in which a mobile station device 90 roams from a Home Public Land Mobile Network (HPLMN) to a Visited Public Land Mobile Network (VPLMN), and in which access to a CSG cell 910 and macrocell 930 of the VPLMN is possible.

In this case, the HPLMN is a network operated by a network operator to which the mobile station device 90 is subscribed. At the HPLMN, by registering the ID of the HPLMN into the subscriber-specific IMSI (International Mobile Subscriber Identity) of a subscriber of the SIM card of the mobile station device 90, it is possible to use the communication service of the registered network operator. In FIG. 9, an HPLMN macrocell 920 is formed by the macrocell base station device 92.

Although the mobile station device 90 is not subscribed to the VPLMN, this is a network operated by a network operator with which there is a contract enabling roaming. In FIG. 9, the base station device 93 of the macrocell forms the macrocell 930 of the VPLMN. Also, the subscriber-specific base station device 91 forms the CSG cell 910 of the VPLMN. In 3GPP E-UTRA, in addition to these, Equivalent Public Land Mobile Networks (EPLMNs) that are treated as being equivalent to HPLMNs are, for example, defined. In 3GPP E-UTRA, macrocells or CSG cells and hybrid cells and the like are formed in each of the various types of PLMNs. An EPLMN differs from an HPLMN in that it is treated as being equivalent to an HPLMN that is explicitly indicated from the network.

The mobile station device 90 performs initial registration into the macrocell 920 of the HPLMN at the point P_{A} in FIG. 9. Next, the user of the mobile station device 90, by manual CSG selection, performs registration into the CSG cell 910 of the VPLMN. By doing this, the mobile station device 90 starts communication in the manually selected CSG cell 910. If the CSG cell 910 gives an instruction for handover to the macrocell 930 of the VPLMN by the mobile station device 90 moving, for example, to the point P_{B}, and the mobile station device 90 performs handover from the CSG cell 910 to the macrocell 930, communication is continued in the service area of the macrocell 930. Then, when the communication is completed, it is completed, with the mobile station device remaining in the service area of the macrocell 930.

In this manner, at the point P_{B}, the CSG 910 and the macrocell 930 belong to the same VPLMN. As a result, there is a possibility that the CSG cell 910 gives an instruction for a handover to the macrocell 930. In mobile communication systems including W-CDMA and LTE, because the selection of a network (base station device) to be connected to by a mobile station device during communication is implemented by control of the network, no method exists for a mobile station device to select a cell at a location to which it is traveling. In general, because the charges for communication with a macrocell of a VPLMN are expensive compared to communication in an HPLMN or communication in a CSG cell, there is a desire to communicate only in CSG cells.

Patent Reference 1 describes, separate from LTE, a communication terminal device that suppresses unnecessary handover. In Patent Reference 1, a base station device transmits a control signal to a communication terminal device and suppresses unnecessary handovers by lowering the frequency of cell searching by switching the operation of the communication terminal device.

### PRIOR ART DOCUMENTS

### Patent Reference

[Patent Reference 1] Japanese Unexamined Patent Application, First Publication No. 2007-27877

### Non-Patent References

[Non-Patent Reference 1] “3GPP TS 22.220 V9.3.0” [online], [retrieved on Sep. 10, 2010]; retrieved from the Internet: (URL: http://www.3gpp.org/ftp/Specs/archive/22_series/22.220/22220-930.zip).
[Non-Patent Reference 2] “S1-094031-Manual-CSG-across-PLMN.doc”, [online], [retrieved on Sep. 10, 2010]; retrieved from the Internet: (URL: http://www.3gpp.org/ftp/tsg_sa/WG1_Serv/TSGS1_{—}48_Beijing/tdocs/S1-094031.zip)

### SUMMARY OF THE INVENTION

### Problem to be Solved by the Invention

As described above, because the charges for communication with a macrocell of a VPLMN are expensive compared to communication in an HPLMN or communication in a CSG cell, there is a desire to communicate only in CSG cells. In current communication systems, however, there is a problem of a lack of a method for selecting a cell at a location to which a mobile station device travels.

Patent Reference 1 proposes the transmission of a control signal from a base station device within the service area of the current cell, and the use of the signal to switch the operation of a mobile station device. When this is implanted with CSG cells, however, in addition to the necessity for the CSG cells to have a transmitter for transmitting a control signal, it is necessary that the base station device recognize the state of the mobile station device and properly change the operation, thereby making complex control necessary.

In order not to require complex control between the base station device and a mobile station device and to minimize the influence on the size of existing systems, it is desirable to have an arrangement in the mobile station device for the suppression of handover.

The present invention has been made in consideration of the above-noted situation, and has as an object the suppression of handover to a macrocell of a VPLMN by controlling so that measurement of neighboring cells is not executed when a PLMN of a CSG cell of the current service area in which a mobile station device is located is judged, and in which the CSG cell belongs to a VPLMN of the mobile station device.

### Means to Solve the Problem

(1) A first aspect of the present invention is a handover control method of a mobile station device moving between a macrocell and a CSG cell, the handover control method of the mobile station device including: determining whether or not the mobile station device is within the CSG cell; determining whether or not the CSG cell is an HPLMN, in case that it is determined that the mobile station device is within the CSG cell; executing a neighboring cell measurement and performing handover, in case that it is determined that the CSG cell is the HPLMN, and in case that the mobile station device is set to measure the neighboring cell; and not measuring the neighboring cell, in case that it is determined that the CSG cell is not the HPLMN, and even in case that the mobile station device is set to measure the neighboring cell.
(2) In the first aspect of the present invention, the method not measuring the neighboring cell may be performed so that a receiving level measurement unit in the mobile station device that measures the receiving level of the neighboring cell is stopped.
(3) A second aspect of the present invention is a handover control method of a mobile station device moving between a macrocell and a CSG cell, the handover control method of the mobile station device including: determining whether or not the mobile station device is within the CSG cell; determining whether or not the CSG cell is an HPLMN, in case that it is determined that the mobile station device is within the CSG cell; and transmitting a handover refusal signal, in case that it is determined that the CSG cell is not the HPLMN.
(4) A third aspect of the present invention is a handover control method of a base station device communicating with a mobile station device, the handover control method of the base station device including: determining whether or not to permit handover, based on a handover refusal signal received from the mobile station device; instructing a VPLMN so that the mobile station device executes a neighboring cell measurement, in case that it is determined to permit handover; and instructing the VPLMN so that the mobile station device does not measure the neighboring cell, in case that it is determined not to permit handover.
(5) In the third aspect of the present invention, the handover control method of the base station device, further may include: controlling the mobile station device so as to stop the neighboring cell measurement, in case that execution of the neighboring cell measurement is set in the mobile station device.
(6) In the third aspect of the present invention, in the handover control method of the base station device, wherein, in case that the execution of the neighboring cell measurement is not set in the mobile station device, the base station device may not transmit to the mobile station device a neighboring cell measurement instruction.
(7) A fourth aspect of the present invention is a mobile station device connected to a PLMN having a macrocell and a CSG cell, the mobile station device including: a receiving signal level measurement unit configured to measure a cell in which the mobile station device is located and a neighboring cell; a control data storage unit configured to set in which the measurement of the cell in which the mobile station device is located and the neighboring cell; a handover determination unit configured to determine whether or not the mobile station device is within the service area of the CSG cell; a cell determination unit configured to determine, in case that the handover determination unit determines that the mobile station device is within the service area, whether or not the CSG cell, in the service area of which the mobile station device is located, is an HPLMN; and a handover refusal signal generation unit configured to generate a handover refusal signal, wherein, in case that the CSG cell in which the mobile station device is located is the HPLMN, and in case that the control data storage unit is set so as to measure a neighboring cell, the neighboring cell measurement is executed and handover is performed, and in case that the CSG cell in which the mobile station device is located is not the HPLMN, and even in case that the control data storage unit is set so as to measure a neighboring cell, the neighboring cell is not measured, or a handover refusal signal is generated.
(8) A fifth aspect of the present invention is a base station device communicating with a mobile station device, the base station device including: a handover determination unit configured to determine, based on a handover refusal signal received from the mobile station device, whether or not to permit handover of the mobile station device; a measurement execution control unit configured to control, based on the determination result of the handover determination unit, the execution of the neighboring cell measurement by the mobile station device; and a control signal generation unit configured to generate a control signal that controls the mobile station device, wherein the control signal generation unit is configured to generate, based on an instruction from the measurement execution control unit, a control signal that stops the neighboring cell measurement.

### Effect of the Invention

According to the present invention that operates as described above, because a mobile station device located within the service area of a CSG cell does not perform handover to the macrocell of a VPLMN, the user of the mobile station device can obtain a benefit in terms of charges.

There is also an effect that, the mobile station device continuing to communicate in a CSG cell suppresses an increase in the communication load on the macrocell operated by the network operator operating the VPLMN.

### BRIEF DESCRIPTION OF THE DRAWINGS

FIG. 1 is a simplified drawing showing an example of the constitution of a mobile communication system of the present invention.

FIG. 2 is a simplified block diagram showing an example of the constitution of a mobile station device 20 of the present invention.

FIG. 3 is a flowchart describing the handover control method according to a first embodiment of the present invention.

FIG. 4 is a sequence diagram at the time of handover refusal according to a second embodiment of the present invention.

FIG. 5 is a flowchart describing the handover control method by the mobile station device 20 according to the second embodiment of the present invention.

FIG. 6 is a simplified block diagram showing the constitution of a subscriber-specific base station device 60 according to a third embodiment of the present invention.

FIG. 7 is a flowchart describing the handover control method according to the third embodiment of the present invention.

FIG. 8 is a sequence diagram describing the notification of an RRC message having the LTE specification used in the third embodiment of the present invention.

FIG. 9 is a drawing describing the handover control in Non-Patent Reference 2.

### EMBODIMENT FOR CARRYING OUT THE INVENTION

Embodiments of the present invention are described below. In the embodiments of the present invention, a conventional cell having a wide-ranging service area similar to that described regarding background art will be referred to as a macrocell. A cell performing service in a narrow area or service with respect to only a specific user will be referred to as a home cell (Home NodeB, Home eNodeB, small base station). In particular in a home cell, a home cell that can be accessed only by a subscriber (specific contractor) belonging to a CSG (closed subscriber group) will be referred to as a CSG cell. A network operated by an operator of a network to which a mobile station is subscribed will be referred to as an HPLMN (Home Public Land Mobile Network). A network that, although not subscribed to by a mobile station device, is operated by a network operator that contracts to enable roaming will be referred to as a VPLMN (Visited Public Land Mobile Network). In addition there are EPLMNs (Equivalent Public Land Mobile Networks) and the like that are explicitly indicated as PLMNs and that are treated similarly to an HPLMN from the network side at the time of position registration, macrocells, CSG cells, and hybrid cells and the like that are formed in each of these various PLMNs. In the embodiments to follow, HPLMN includes EPLMN.

As described above, networks in the present embodiment include an HPLMN and a VPLMN. Macrocells and home cells (CSG cells) are formed in each of the HPLMNs and VPLMNs and, in general, the charges required to be paid by a mobile station device when making a communication connection to these cells are not the same. The charge for connection to a macrocell of a VPLMN is the highest, followed by the charge for connection to a macrocell of an HPLMN, and then the charge for connection to a CSG cell of a HPLMN and a CSG cell of a VPLMN, which is the least expensive. In the present embodiment, because of this charging system, it is desirable when within the service area of a CSG cell to remain in the service area of the CSG cell. In the present embodiment, however, as a convenience in communication, connection to a macrocell of an HPLMN is permitted, for the purpose of avoiding connection to a macrocell of a VPLMN. A handover control method, a mobile station device, and a base station device implementing such handover control will be described.

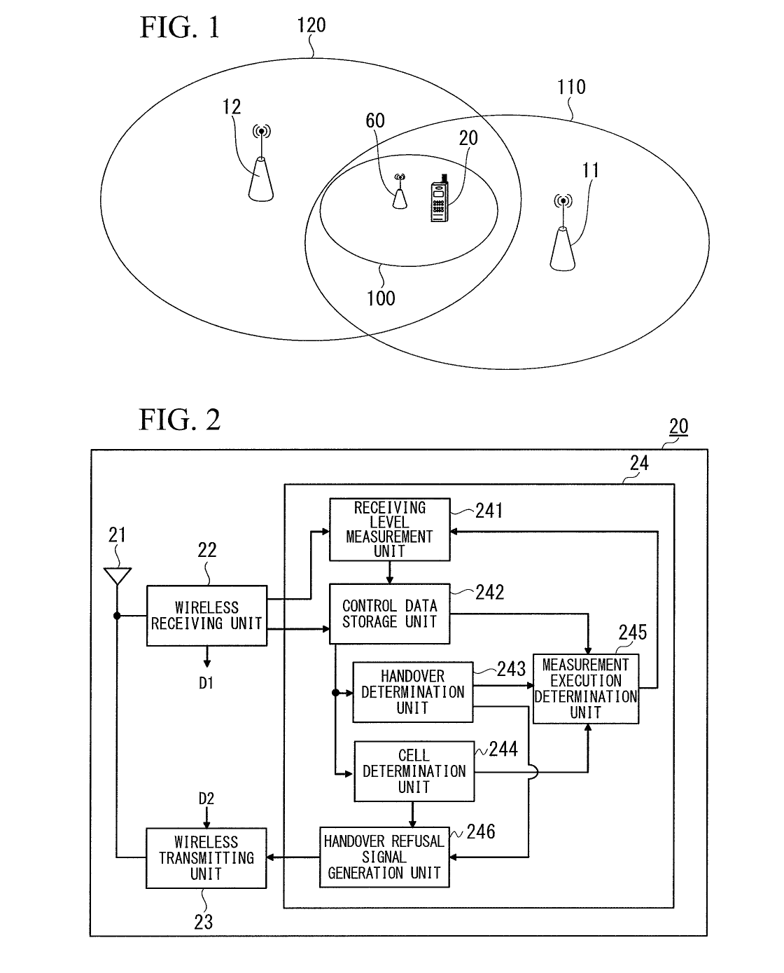

FIG. 1 is a simplified drawing showing an example of the constitution of a mobile communication system of the present invention. As shown in FIG. 1, the mobile communication system showing an example of the present invention is made up of a CSG cell 100 of a VPLMN, a subscriber-specific base station device 60 having the CSG cell 100 of the VPLMN, a macrocell 110 of an HPLMN, a base station device 11 having the macrocell 110 of the HPLMN, a macrocell 120 of a VPLMN, a base station device 12 having the macrocell 120 of the VPLMN, and a mobile station device 20. The mobile station device 20 is at a position enabling communication with each of the CSG cell 100 of the VPLMN, the macrocell 110 of the HPLMN, and the macrocell 120 of the VPLMN.

FIG. 2 is a simplified block diagram showing an example of the constitution of the mobile station device 20 of the present invention. FIG. 2 will now be described. In FIG. 2, only the parts required to describe an example of the present invention are shown, with other constituent elements, display units, and operating units used in usual wireless communication being omitted. The mobile station device 20 has an antenna 21, a wireless receiving unit 22, a wireless transmitting unit 23, and a control unit 24. The control unit 24 has a receiving level measurement unit 241, a control data storage unit 242, a handover determination unit 243, a cell determination unit 244, a measurement execution determination unit 245, and a handover refusal signal generation unit 246.

The antenna 21 receives and outputs to the wireless receiving unit 22 a wireless signal transmitted by a base station device. The antenna 21 also transmits to the base station device a signal output by the wireless communication unit 23, as a wireless signal. The wireless receiving unit 22, after down-converting the signal output by the antenna 21, demodulates the signal to obtain control data and received data D1. The wireless receiving unit 22 outputs the control data thereof to the control unit 24. The wireless transmitting unit 23, after modulating the control data received from the control unit 24 and the transmitted data D2, up-converts and outputs the data to the antenna 21. As will be described later, the control unit 24 transmits to the base station device, from the cell within the service area of which the mobile station device 20 is located, neighboring cells, and receiving levels and the like, control data regarding handover.

The receiving level measurement unit 241 measures the receiving quality of the radio signal transmitted from the base station device, and stores the measurement result in the control data storage unit 242. The measurement of the receiving quality of the radio signal is performed based on an instruction by the measurement execution determination unit 245, which will be described later. In this case, the receiving level measurement unit 241 may set the frequency band of the cell to be measured into the wireless receiving unit 22 and use a reference signal in that frequency band to calculate the signal-to-noise ratio (S/N), using this as the receiving level. Also, the receiving level measurement unit 241 may set the frequency band of the cell to be measured into the wireless receiving unit 22 and use a reference signal in that frequency band to calculate the received signal power (reference signal received power; RSRP). An S value calculated from the downlink path loss calculated using the RSRP, the RSRP, and a parameter, notification of which is made from the system information, may be used. The reference signal is a signal that is known at the mobile station device 20.

The control data storage unit 242 stores neighboring cell information, notification of which is made from a base station device by the system information, which is a type of control data. The control data storage unit 242 also stores cell information regarding the cell, in the service area of which the mobile station device is currently located, and information indicating the receiving level of each cell that is measured by the receiving level measurement unit 241. In this case, the neighboring cell information and cell information is information identifying a cell (mainly, the cell ID), the cell type (macrocell, CSG cell, or the like), and information indicating network information (the PLMN ID) and the like. The cell information is information regarding the cell, in the service area of which the mobile station device is currently located, and the neighboring cell information is information regarding cells neighboring the cell, in the service area of which the mobile station device is currently located. The control data storage unit 242 also stores cell measurement instructions and measurement conditions (measurement configuration), notification of which is made from a base station device. The control data storage unit 242 obtains, based on the IMSI (International Mobile Subscriber Identity) within the SIM of a mobile station device 20, the MCC (Mobile Country Code) and the MNC (Mobile Network Code) and stores these. The IMSI is a subscriber identifier (sometimes translated as the international mobile subscriber identification number), and the MCC is a country name code in the mobile communication indicating the region of operation. The MNC is a code indicating the telecommunications operator. The control data storage unit 242 also stores the handover conditions preset by a user or network used by the handover determination unit 243, which will be described later.

The handover determination unit 243 recognizes, from the MCC and the MNC obtained from the control data storage unit 242, the HPLMN to which the mobile station device 20 is subscribed. Next, the handover determination unit 243, based on the cell information and neighboring cell information obtained from the control data storage unit 242, recognizes the PLMN ID of each cell. The handover determination unit 243 then compares this with the HPLMN ID to which the recognized mobile station device 20 is subscribed, and recognizes which cells of the cell in the service area of which the mobile station device is located and the neighboring cells are HPLMN and which cells are VPLMN. The handover determination unit 243, based on the cell information and the neighboring cell information obtained from the control data storage unit 242, recognizes which cells of the cell in the service area of which the mobile station device is located and the neighboring cells are CSG cell and which cells are or are not macrocells. Next, the handover determination unit 243 makes a comparison between handover conditions obtained from the control data storage unit 242 and that have been preset by the user or the network and the information previously recognized regarding cell in the service area of which the mobile station device is located and regarding the neighboring cells, and judges whether or not the mobile station device 20 can execute a handover. For example, the handover determination unit 243 makes a setting so that handover to a macrocell of the VPLMN is not done when the user is in the service area of a CSG cell of the VPLMN. Based on the information regarding the cell the service area of which the mobile station device is currently located and regarding the neighboring cells, if it is judged that the mobile station device 20 is within the service area of a CSG cell of a VPLMN, and a neighboring cell is a VPLMN macrocell, the handover determination unit 243 determines that handover is not to be permitted. Alternatively, the setting is made so that handover to a VPLMN macrocell is performed even when a user is in the service area of a VPLMN CSG cell. The handover determination unit 243 determines to permit a handover, when it is judged that the mobile station device 20 is within the service area of an HPLMN CSG cell and a neighboring cell is a VPLMN macrocell, based on information of the cell in which the mobile station device is currently located and of neighboring cells. Further, the user or the network can arbitrarily set what type of handover to permit.

The cell determination unit 244, based on the MCC and MNC obtained from the control data storage unit 242, recognizes the HPLMN to which the mobile station device 20 is subscribed. Next, the cell determination unit 244, based on the cell information and neighboring cell information obtained from the control data storage unit 242, recognizes the PLMN ID of each cell. The cell determination unit 244 then compares these with the recognized ID of the HPLMN to which the mobile station device 20 is subscribed, and determines which cells of the cell in which the mobile station device is currently located and the neighboring cells are HPLMN and which cells are VPLMN. The cell determination unit 244 also determines, based on cell information and neighboring cell information obtained from the control data storage unit 242, which cells of the cell in which the mobile station device is currently located and the neighboring cells are CSG cells and which cells are macrocells.

The measurement execution determination unit 245 determines whether or not a neighboring cell measurement is to be executed. When the measurement execution determination unit 245 determines that a neighboring cell measurement is to be executed, it outputs the measurement instruction and the measurement conditions (the measurement configuration) obtained from the control data storage unit 242 to the receiving level measurement unit 241. When the measurement execution determination unit 245 determines that a neighboring cell measurement is not to be executed, it outputs a measurement-stopping instruction to the receiving level measurement unit 241. Because the mobile station device 20 cannot execute a handover to a cell for which a measurement is not executed, it is possible to stop a handover to a cell to which a handover is not desired by stopping the measurement of the cell. The determination of whether or not to execute the measurement is made by all or a part of the handover determination result obtained from the handover determination unit 243, the information of the cell in the service area of which the mobile station device is currently located and the neighboring cells obtained from the cell determination unit 244, and control data such as a neighboring cell measurement instruction obtained from the control data storage unit 242.

The handover refusal signal generation unit 246 obtains information of the cell type (CSG or macrocell) of each cell and the network information (HPLMN or VPLMN) from the cell determination unit 244. The handover refusal signal generation unit 246 compares the obtained type information and network information with the pre-given settings or settings by a user operation, determines cells to which a handover is not desired, and generates and outputs to the wireless transmitting unit 23 a handover refusal signal. For example, when the user is within the service area of a CSG cell of a VPLMN, the handover refusal signal generation unit 246 makes a setting so that a handover is not made to VPLMN macrocell. When data that the cell in which the mobile station device is currently located is a CSG cell and that a VPLMN macrocell exists as a neighboring cell is obtained from the cell determination unit 244, the handover refusal signal generation unit 246 generates and outputs to the wireless transmitting unit 23 a VPLMN macrocell handover refusal signal. The wireless transmitting unit 23 transmits the handover refusal signal as one control signal to the base station device of the cell in which the mobile station device is currently located, either together with other control signals or separately. Although the handover refusal signal is transmitted when there has been a handover instruction from the network, transmission may be made also when the cell determination unit 244 discriminates each cell, even if there is no handover instruction. The handover refusal signal generation unit 246 may generates the handover refusal signal in response to the determination by the handover determination unit 243 as to whether or not to permit a handover.

Embodiments of a handover control method by the mobile station device 20 and the subscriber-specific base station device 60 in an example of the mobile communication system of the present invention described above will be described below. The present invention is not restricted to these embodiments, various forms thereof being possible, within the scope of the invention. The macrocells and CSG cells dealt with in the following embodiments are macrocells and CSG cells set forth in 3GPP E-UTRA. In the following embodiments, the description is for the case of being within the service area of a CSG cell as defined in 3GPP. However, the present invention is not restricted to CSG cells, and, although not defined in 3GPP, the present invention can be applied to femtocells and small base stations having the same functions as CSG cells and hybrid cells defined in 3GPP, to wireless access points, and to relay stations and the like.

### First Embodiment

In the first embodiment, the object is not to execute handover to a neighboring cell by not measuring the neighboring cell when the mobile station device is within the service area of a VPLMN CSG cell.

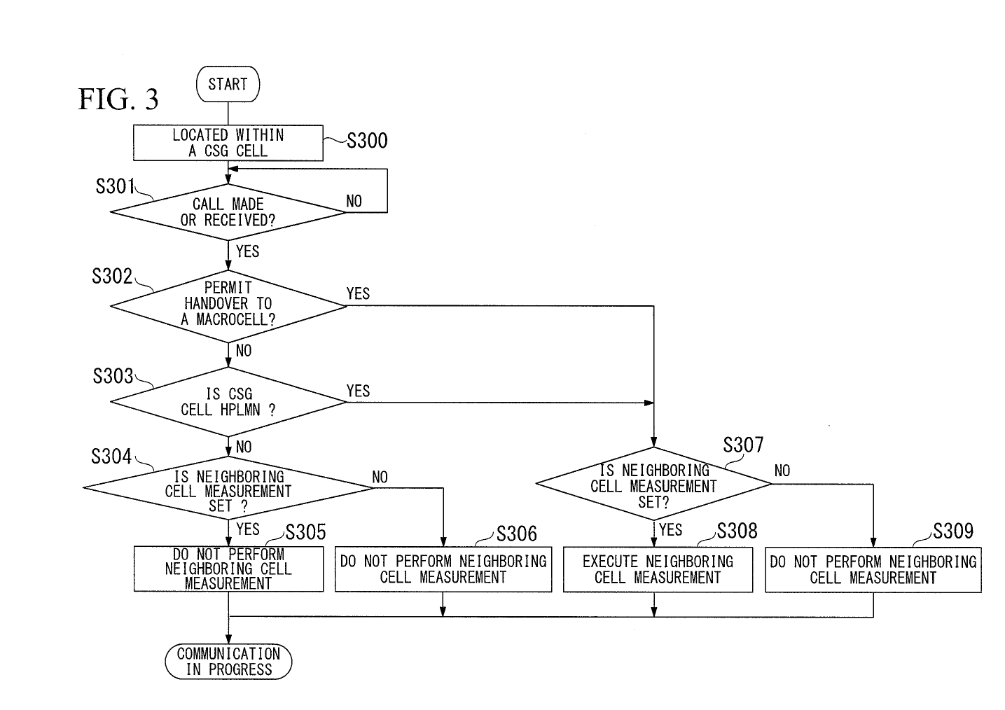

FIG. 3 is a flowchart describing the handover control method of the first embodiment. Within the constitution of the mobile communication system of FIG. 1, an example of the mobile station device 20 of FIG. 2 executing the flowchart of FIG. 3 will be described.

The mobile station device 20, by manual CSG selection by a user, is within the service area of the VPLMN CSG cell 100 (step S300). If the mobile station device 20 starts communicating by making a call or receiving a call (Yes at step S301), the handover determination unit 243 of the mobile station device 20 determines whether or not handover to a neighboring macrocell is permitted by the determination means already described (step S302). In this case, handover to the VPLMN macrocell 120 is not permitted. If the mobile station device is within the service area of the VPLMN CSG cell 100, handover to the HPLMN macrocell 110 is not executed. As a result, a determination is not made to permit handover to the HPLMN macrocell 110. Therefore, processing proceeds to step S303. At step S303, the cell determination unit 244 of the mobile station device 20, by the determination means already described, determines the network of the CSG cell in which the mobile station device is currently located. In this case, because the CSG cell is in a VPLMN (No at step S303), processing proceeds to step S304. At step S304, if the mobile station device 20 is set to measure the neighboring cells on its own, or is set to measure neighboring cells by a network instruction (Yes at step S304), the measurement execution determination unit 245 determines not to execute a measurement. The measurement execution determination unit 245 then outputs to the receiving level measurement unit 241 an instruction not to execute a measurement. By doing this, the receiving level measurement unit 241 does not measure neighboring cells (step S305). Because the mobile station device 20 does not measure the neighboring cells, handover is not done to the VPLMN macrocell 120, and communication is executed while remaining in the service area of the VPLMN CSG cell 100. When the measurement of neighboring cells is not set (No at step S304), the mobile station device 20 does not perform a measurement (step S306). As a result, the mobile station device 20 does not perform handover to the VPLMN macrocell 120 and executes communication while remaining in the service area of the CSG cell 100.

The steps S307 to S309 are the processing when a user located within the service area of the VPLMN CSG cell 100 permits handover to a VPLMN macrocell, or when a user is in the service area of an HPLMN CSG cell. In these cases, in the first embodiment, handover to an HPLMN macrocell is permitted. For this reason, if neighboring cell measurement is set at step S307 (Yes at step S307), the measurement execution determination unit 245 determines to execute the measurement, and outputs to the receiving level measurement unit 241 an instruction to execute the measurement. As a result, a neighboring cell measurement is executed at step S308, and handover to an HPLMN macrocell is possible. Even when the neighboring cell measurement of step S308 ends, after communication by the CSG cell 100 continues, transition is made to the actual handover processing. FIG. 3 is a flowchart showing the processing up until the continuation of communication by the CSG cell 100, and does not show the handover processing after step S308. Also, when neighboring cell measurement is not set (No at step S307), because neighboring cell measurement is not performed at step S309, communication is continued by the CSG cell 100 without making a handover.

As described above, in the first embodiment, when the mobile station device is in the service area of a VPLMN CSG cell, by making it so that neighboring cell measurement is not performed, a handover control method is implemented whereby control is performed so that handover to a neighboring cell is not performed. By doing this, the effects are that of the mobile station device not handing over to a VPLMN macrocell having a high charge and that of suppressing the power consumption by not measuring the neighboring cell. Also, there is an effect that, by the mobile station device continuing to communicate by the CSG cell, it is possible to suppress an increase in the communication load on the macrocell operated by the network operator that operates the VPLMN. There is also an effect that the mobile station device alone controls this type of handover.

### Second Embodiment

In the second embodiment, when a change occurs in the communication condition of a mobile station device in the service area of a CSG cell, such as by receiving or making a call, handover has been controlled by making it so that neighboring cell measurement is not performed. In contrast, in the second embodiment, when a handover instruction from the network occurs when the mobile station device is in the service area of a CSG cell, if the user does not wish to communicate by a macrocell, handover control is performed by the mobile station device transmitting a handover refusal signal to the cell in which the mobile station device is currently located. In this case, the cell in which the mobile station device is currently located is a CSG cell. In the second embodiment as well, similar to the first embodiment, the mobile station device obtains information such as the network type and the cell type, and uses this information in handover control.

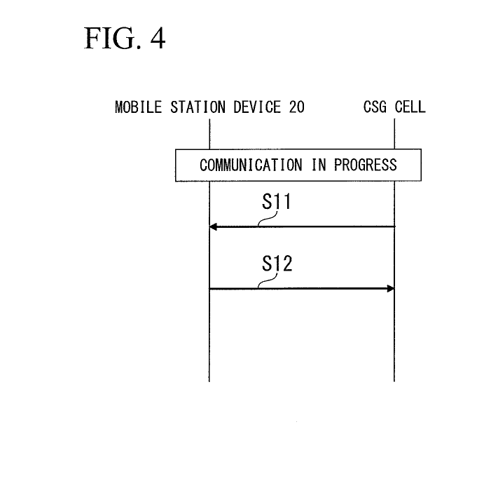

For example, in the case of congestion within a CSG cell, by the first message of the air sequence shown in FIG. 4, a handover instruction from the network is made from the CSG cell to the mobile station device (step S11). For example, when using W-CDMA, the first message is a message with regard to physical channel reconfiguration, radio bearer reconfiguration, or the like.

In the case of the mobile station device not performing handover, by the second message of the air sequence shown in FIG. 4, the mobile station device 20 transmits a handover refusal signal to the CSG cell (step S12). For example, when W-CDMA is used, the second message is a message with regard to physical channel reconfiguration failure.

In the second embodiment, similar to the first embodiment, although it is desired to communicate by a CSG cell, handover to an HPLMN macrocell is permitted, the object being to avoid handover to a VPLMN macrocell.

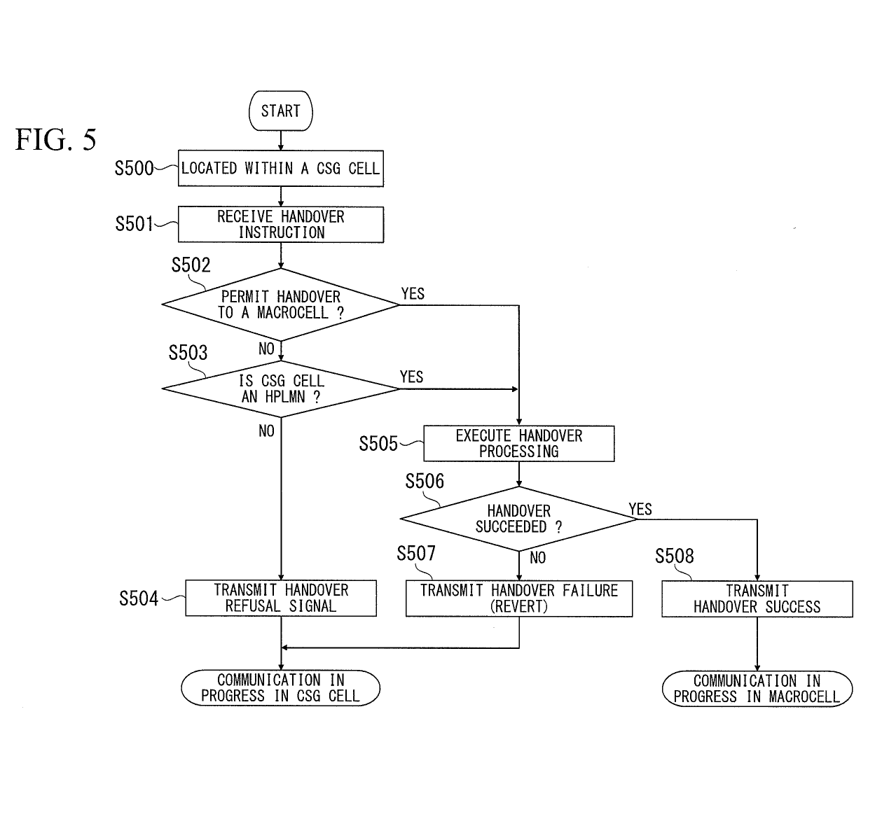

FIG. 5 is a flowchart describing the handover control method of the second embodiment. FIG. 5 will now be described. With the mobile station device 20 in the condition of being within the service area of the VPLMN CSG cell 100, as shown in FIG. 1 (step S500 in FIG. 5), when an instruction for handover from the CSG cell 100 to the VPLMN macrocell 120 is received (step S501), the handover determination unit 243 of the mobile station device 20, by the already-described determination means, determines whether or not handover to a neighboring macrocell is permitted (step S502). In the second embodiment as well, if handover to the VPLMN macrocell 110 is not permitted and the mobile station device is in the service area of the VPLMN CSG cell 100, handover to the HPLMN macrocell 110 is not executed. As a result, in this case, determination is not made to permit handover to the HPLMN macrocell 110, and processing proceeds to step S503. In this case, because the CSG cell is a VPLMN cell (No at step S503), processing proceeds to step S504. In the second embodiment, the cell in which the mobile station device is currently located is a CSG cell, and a neighboring cell is a VPLMN macrocell. For this reason, at step S504, by an already-described means, the handover refusal signal generation means 246 generates and outputs to the wireless transmitting unit 23 a handover refusal signal. Therefore, the wireless transmitting unit 23 transmits a handover refusal signal to the subscriber-specific base station device 60 of the CSG cell 100, and the mobile station device 20 continues communication with the CSG cell 100. In this manner, in the second embodiment, when the mobile station device 20 receives an instruction for handover to a neighboring macrocell while communicating with the VPLMN CSG cell 100, it transmits a handover refusal signal to the CSG cell. As a result, the mobile station device makes it so that handover to a VPLMN macrocell is not executed.

Steps S505 to S506 are the processing when a user located within the service area of the VPLMN CSG cell 100 permits handover to the VPLMN macrocell 120, or in which a user is in the service area of an HPLMN CSG cell. In these cases, in the second embodiment, because handover to the HPLMN macrocell 110 is permitted, processing proceeds to either step S502 or step S503 to S505, and handover processing is executed. If the handover succeeds (Yes at step S506), the mobile station device transmits a handover successful signal to the CSG cell 100 (step S508) and communicates by the macrocell 110. If the handover fails (No at step S506), the mobile station device transmits a handover failure signal to the CSG cell 100 (step S507), and continues to communicate by CSG cell 100.

In this manner, when the mobile station device 20 of the second embodiment receives an instruction for handover to a neighboring macrocell while communicating with the VPLMN CSG cell 100, determination of handover to a neighboring macrocell and determination of the cell type are performed, and a handover refusal signal is transmitted to the CSG cell. As a result, handover to a VPLMN macrocell is not executed.

At step S504, the network may be notified that handover is not permitted. The handover refusal signal generation unit 246 generates and transmits from the wireless transmitting unit 23 to the CSG cell a signal indicating that handover is not permitted. It is desirable that the network that receives this signal indicating that handover is not permitted from the CSG cell stores this information and performs control so that subsequent handover instruction messages are not transmitted.

As described above, in the second embodiment, if the mobile station device is in the service area of a CSG cell and the user does not wish to communicate by a macrocell, a handover refusal signal is transmitted with respect to a handover instruction signal transmitted from the CSG cell to perform handover to a neighboring macrocell. By doing this, a handover control method and mobile station device that perform control so that handover to a neighboring cell is not executed are implemented. By doing this, the effect is that of the mobile station device not handing over to a VPLMN macrocell having a high charge. Also, there is the effect that, by the mobile station device continuing to communicate by the CSG cell, it is possible to suppress an increase in the communication load on the macrocell operated by the network operator that operates the VPLMN.

### Third Embodiment

In the first embodiment, the mobile station device performs handover control. In contrast, in the third embodiment, the base station device that communicates with the mobile station device 20 of the second embodiment performs handover control. Specifically, when it receives a handover refusal signal from the mobile station device 20 of the second embodiment, the base station device controls the operation of the network or controls the measurement of neighboring cells by the mobile station device. By doing this, in the third embodiment, control is performed of handover to neighboring cells of the mobile station device 20.

In the third embodiment as well, similar to the first and second embodiments, the base station device forming the CSG cell will be referred to as a subscriber-specific base station device. The third embodiment will be described below, using as an example communication between the subscriber-specific base station device, the CSG cell of that subscriber-specific base station device, and a mobile station device.

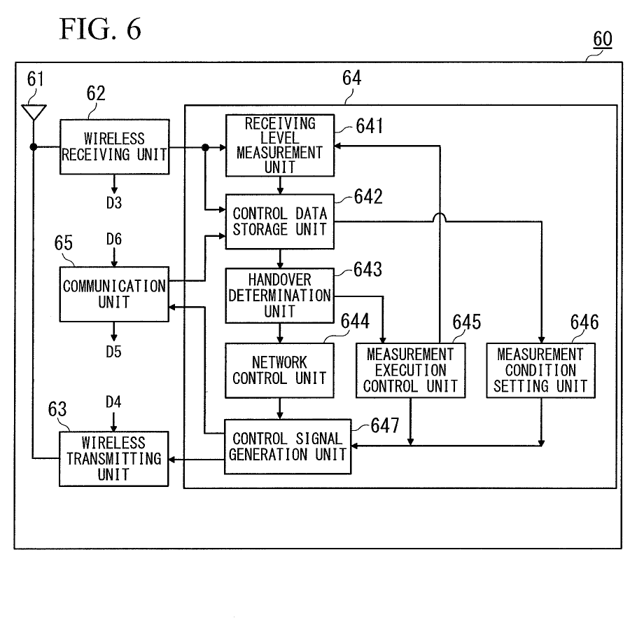

FIG. 6 is a simplified block diagram showing the constitution of the subscriber-specific base station device 60 of the third embodiment of the present invention. Only those constituent elements of the subscriber-specific base station device 60 necessary to describe the third embodiment of the present invention are shown, with the description and illustration of other constituent elements, display devices, and operating units used in usual wireless communication being omitted.

The subscriber-specific base station device 60 has an antenna 61, a wireless receiving unit 62, a wireless transmitting unit 63, a control unit 64, and a communication unit 65. The control unit 64 has a receiving level measurement unit 641, a control data storage unit 642, a handover determination unit 643, a network control unit 644, a measurement execution control unit 645, a measurement condition setting unit 646, and a control signal generation unit 647.

The antenna 61 receives and outputs to the wireless receiving unit 62 a wireless signal transmitted by the mobile station device. The antenna 61 transmits the signal output by the wireless transmitting unit 63 as a wireless signal to the mobile station device. The wireless receiving unit 62, after down-converting the signal output by the antenna 61, demodulates it to obtain control data and received data D3. The wireless receiving unit 62, of these, outputs the control data to the control unit 64. The wireless transmitting unit 63, after modulating the control data received from the control unit 24 and the transmitted data D4, performs up-conversion and outputs these to the antenna 61. The control unit 64, based on a handover refusal signal transmitted from the mobile station device as will be described later, generates a control signal that performs control regarding network or mobile station device handover, and transmits this control signal to the network or the mobile station device.

The receiving level measurement unit 641 measures the receiving quality of the radio signal transmitted from the mobile station device and stores the measurement result into the control data storage unit 242. The measurement by the receiving level measurement unit 641 may be performed based on an instruction from the measurement execution control unit 645.

The control data storage unit 642 stores control data for controlling the mobile station device provided in the subscriber-specific base station device 60 beforehand, along with control data received from the mobile station device or network via the wireless receiving unit 62 or the communication unit 65, and results of measurement by the receiving level measurement unit 641. The control data stored by the control data storage unit 642 is, for example, a handover refusal signal indicating that a mobile station device does not permit a handover to a neighboring cell, user contract information, the neighboring wireless environment, and conditions for measurement of the cell in which the mobile station device is currently located and neighboring cells.

The handover determination unit 643 obtains from the control data storage unit 642 information regarding handover of the mobile station device, and determines whether or not to permit the mobile station device handover. The method of making the determination is to determine that handover is not to be permitted when a handover refusal signal is transmitted from the mobile station device. Alternatively, the handover determination unit 643 may obtain and compare the mobile station device MCC, MNC, the cell information, and neighboring cell information, so that it may recognize a cell in which the mobile station device is located, a cell type of the neighboring cell, and network information, and compare this with pre-established handover permission conditions and determine whether or not handover is to be permitted. The pre-set handover permission conditions are conditions that are pre-determined by the network operator. For example, from the receiving level measurement result of the subscriber-specific base station device 60 and the mobile station device measured by the receiving level measurement unit 641, when the receiving level is higher than a pre-established threshold, the determination is made that handover is not to be permitted.

The network control unit 644, based on the determination result of the handover determination unit 643, controls the operation of the network. When handover to a neighboring cell of the mobile station device is not permitted, the network is controlled so that an instruction is not made from the network to the mobile station device to execute a neighboring cell measurement. When handover is permitted the network control unit 644 instructs the mobile station device via the network so as to execute a neighboring cell measurement. The network control unit 644 instructing the control signal generation unit 647 executes network control to generate a network control signal, and the control signal generation unit 647 transmits the generated control signal from the communication unit 65 to the network.

The measurement execution control unit 645, based on the determination result of the handover determination unit 643, controls the neighboring cell measurement by the mobile station device. Specifically, when the handover determination unit 643 determines that the mobile station device does not permit handover, the measurement execution control unit 645 outputs to the control signal generation unit 647 an instruction to generate a control signal that stops the neighboring cell measurement by the mobile station device. By doing this, the mobile station device stops the neighboring cell measurement. When, however, the handover determination unit 643 determines that the mobile station device permits handover, the measurement execution control unit 645 outputs to the control signal generation unit 647 an instruction to generate a control signal so that the neighboring cell measurement is executed by the mobile station device. By doing this, the mobile station device executes a neighboring cell measurement.

From the conditions for measurement of the cell in which the mobile station device is currently located and the neighboring cells stored in the control data storage unit 642, the measurement results of the receiving level measurement unit 641, and the like, the measurement condition setting unit 646 sets conditions for a new measurement of the cell in which the mobile station device is currently located and neighboring cells done by the mobile station device. The measurement conditions stored in the control data storage unit 642 include those that are stored in the control data storage unit 642 beforehand, and those that the mobile station device has beforehand and that are received from the mobile station device and stored therein. The measurement condition setting unit 646 outputs the measurement conditions set anew to the control signal generation unit 647. The measurement conditions being set anew by the measurement condition setting unit 646 includes the case in which the wireless transmitting unit 63 transmits a signal as a control signal from the control signal generation unit 647 to the mobile station device and the case in which the communication unit 65 transmits to the network.

The control signal generation unit 647 generates as control signals all or a part of the data output by the network control unit 644, the measurement execution control unit 645, and the measurement condition setting unit 646. The control signal generation unit 647 transmits the generated control signals from the wireless transmitting unit 63 to the mobile station, and from the communication unit 65 to the network.

The communication unit 65 is a communication interface unit for making connection to the network. The communication unit 65 is connected to a cable network such as a LAN or an optical line or the like, and is connected to the operator network via the Internet. The communication unit 65 obtains control data and the received data D5 from the network. For example, the communication unit 65 obtains user contract information, surrounding wireless environment, and the like from an operator, and outputs them to the control data storage unit 642. The communication unit 65 also transmits control signals received from the control signal generation unit 647 and transmitted data D6 to the network.

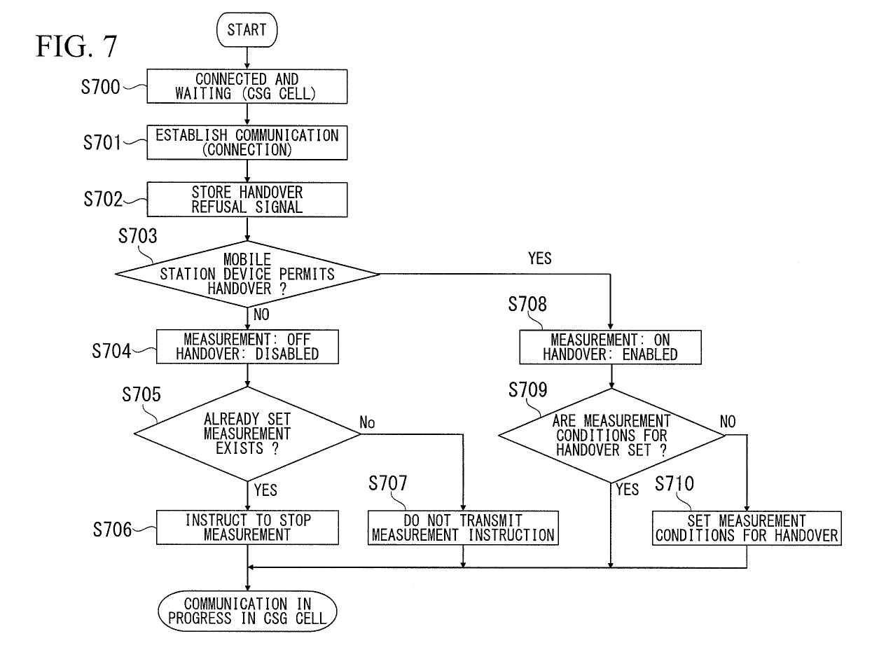

FIG. 7 is a flowchart describing the handover control method of the third embodiment. FIG. 7 will now be described. As shown in FIG. 1, the mobile station device 20 is waiting within the service area of the subscriber-specific base station device 60 (step S700 in FIG. 7). In this condition, when there is a call made by the mobile station device 20 or a call received by the mobile station device 20, a communication connection is established between the mobile station device 20 and the subscriber-specific base station device 60 (network) (step S701). When this occurs, if the subscriber-specific base station device 60 receives a handover refusal signal from the mobile station device 20, it stores the signal in the control data storage unit 642 (step S702).

If the user of the mobile station device 20 refuses handover to a neighboring cell, the handover determination unit 643 determines not to permit handover of the mobile station device 20 (No at step S703). As a result, the subscriber-specific base station device 60 changes the operation of the network and disables the handover of the mobile station device 20. Specifically, the network control unit 644 instructs the control signal generation unit 647 to generate a control signal so that the mobile station device 20 is not instructed by the network to measure the neighboring cells (measurement: off), and outputs this to the network via the communication unit 65 (step S704). By doing this, the mobile station device does not execute measurement of neighboring cells by an instruction from the network.

If the mobile station device 20 does not permit handover and there are measurement conditions in the mobile station device 20 by notification information or the like (Yes at step S705), the measurement execution control unit 645 instructs the control signal generation unit 647 to generate a control signal that stops the execution of neighboring cell measurement by the mobile station device 20. The wireless transmitting unit 63 then transmits the generated control signal to the mobile station device 20, stopping the neighboring cell measurement by the mobile station device (step S706). By doing this, the execution of neighboring cell measurement by the mobile station device on its own is also stopped. If there were no measurement conditions in the mobile station device 20 beforehand (No at step S705), the measurement execution control unit 645 does not make an instruction to execute measurement (step S707). By doing this, there also is no neighboring cell measurement by the mobile station device in accordance with an instruction by the subscriber-specific base station device 60.

If, by the processing at step S703, the user of the mobile station device 20 permits handover (Yes at step S703), the network control unit 644 instructs the control signal generation unit 647 to generate a control signal by which the network instructs the mobile station device 20 to execute neighboring cell measurement (measurement: on). The network control unit 644 then outputs this to the network via the communication unit 65 (step S708). By doing this, handover of mobile station device 20 by an instruction from the network is enabled. If there are no measurement conditions in the mobile station device 20 beforehand (No at step S709), the measurement condition setting unit 646 obtains from the control data storage unit 642 measurement conditions for handover. The measurement condition setting unit 646 then gives an instruction to the control signal generation unit 647 to generate a control signal that includes the obtained measurement conditions, and transmission is made thereof from the wireless transmitting unit 63 to the mobile station device (step S710). By doing this, the measurement conditions for handover are set into the mobile station device 20, which goes into the condition in which handover execution is enabled. If there are measurement conditions in the mobile station device 20 beforehand (Yes at S709), the subscriber-specific base station device 60 does nothing in particular, and the mobile station device 20 communicates with the CSG cell in the condition in which the execution of normal handover is enabled. The flowchart of FIG. 7 shows the processing before executing the handover sequence.

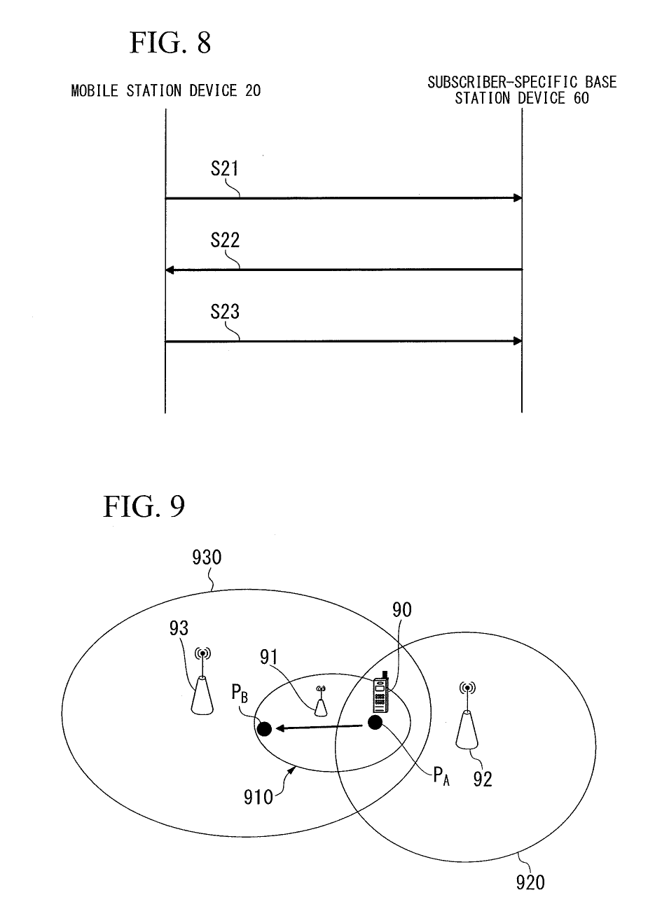

Notification of the signals exchanged between the mobile station device 20 and the subscriber-specific base station device 60, such as the handover refusal signal at step S702 and the instruction to stop measurement at step S706 may be made by the terminal capability (UE capability) within an RRC (Radio Resource Control) message in accordance with the LTE specifications (for example, 3GPP TS36.331). FIG. 8 shows this notification sequence. In FIG. 8, when the mobile station device 20 and the subscriber-specific base station device 60 (CSG cell) establish communication, the mobile station device 20 transmits an RRC connection request to the subscriber-specific base station device 60 (step S21). The RRC connection request is a signal that is transmitted by the mobile station device to a base station device (or a network device), this being a connection request signal that requests a separate channel connection. Upon receiving the RRC connection request signal, the subscriber-specific base station device 60 transmits an RRC connection establishment (RRC Connection Setup) signal to the mobile station device 20 (step S22). The RRC Connection Setup signal is a message for the purpose of giving notification of the channel setting to be used in the connection between the mobile station device 20 and the subscriber-specific base station device 60, synchronization being established after the mobile station device 20 receives this message. When synchronization is established, an RRC Connection Setup Complete signal, which gives notification that the separate channel connection to the base station device (or network device) has been completed is transmitted (step S23), this completing the establishment of communication.

The notification of the above-described measurement condition setting and execution instruction may be made by system information in which the network sends it within a cell in accordance with the LTE specification, or may set the measurement with respect to the mobile station device by separate signaling (using an RRC measurement control message defined in 3GPP TS25.331 and TS36.331). In either case, the ID (measurement ID) is set for each measurement, these IDs being managed by the network.

As described above, in the third embodiment, the subscriber-specific base station device that suppresses neighboring cell measurement by the mobile station device controls handover. When the subscriber-specific base station device receives a handover refusal signal from the mobile station device 20 of the second embodiment, it determines not to permit handover of the mobile station device 20 to a neighboring cell, controls the operation on the network side, and does not instruct to measure a neighboring cell from the network to the mobile station device. Even when the subscriber-specific base station device instructs to measure a neighboring cell to measure the neighboring cell by notification information or the like, and when it determines not to permit handover, it instructs the mobile station device to stop neighboring cell measurement. When the subscriber-specific base station device instructs to measure a neighboring cell, it does not transmit the instruction to the mobile station device to execute a neighboring cell measurement. By doing this, control can be done so that the mobile station device is not handed over to a neighboring cell. Thus, similar to the cases of the first and second embodiments, when a mobile station device is within the service area of a CSG cell, it is possible to make it so that handover to a VPLMN macrocell, which has a high charge, is not executed. Also, there is also an effect that, the mobile station device continuing to communication by the CSG cell suppresses an increase in the communication load on the macrocell operated by the network operator operating the VPLMN.

A program for the purpose of implementing the functionality of the various units of the mobile terminal device 20 and the subscriber-specific base station device 60 may be recorded in a computer-readable recording medium. The program recorded in the recording medium may then be read into a computer system and executed to implement the functionality of the various units. The term “computer system” as used herein includes an operating system and hardware such as peripheral devices. The term “computer-readable recording medium” refers to a portable medium such as a flexible disk, an opto-magnetic disk, a ROM, or a CD-ROM, and a storage apparatus such as a hard-disk apparatus built into a computer system. Additionally, the term “computer-readable recording medium” may include one that holds a program for a certain period of time, such as the case of transmitting a program via a network such as the Internet or via a communication circuit such as a telephone line, or one such as a volatile memory (RAM) within the computer system that is to become a server or a client.

The above-noted program may be transferred from a computer system, into a storage device of which the program was stored, to another computer system via a transfer medium, or by a transfer radio signal in a transfer medium. In this case, the term “transfer medium” transferring a program refers to a medium having a function of transferring information, such as a network (communication network) such as the Internet, or a communication line such as a telephone line. The above-noted program may be one for implementing a part of the above-described functionality, and may be one for implementing the above-described functionality in combination with a program that has already been recorded within a computer system, this being a so-called difference file (difference program).

### INDUSTRIAL APPLICABILITY

The handover control method, mobile station device, and base station device according to the present invention can be applied to a communication system in which home cells and macrocells coexist.

### REFERENCE SYMBOLS

20, 90 Mobile station device
10, 60, 91 Subscriber-specific base station device
11, 12, 92, 93 Base station device
100, 910 CSG cell
110, 120, 920, 930 Macrocell
21, 61 Antenna
22, 62 Wireless receiving unit
23, 63 Wireless transmitting unit
24, 64 Control unit
65 Communication unit
241, 641 Receiving level measurement unit
242, 642 Control data storage unit
243, 643 Handover determination unit
244 Cell determination unit
245 Measurement execution determination unit
246 Handover refusal signal generation unit
644 Network control unit
645 Measurement execution control unit
646 Measurement condition setting unit
647 Control signal generation unit

1. A handover control method of a mobile station device moving between a macrocell and a CSG cell, the handover control method of the mobile station device comprising:
determining whether or not the mobile station device is within the CSG cell;
determining whether or not the CSG cell is an HPLMN, in case that it is determined that the mobile station device is within the CSG cell;
executing a neighboring cell measurement and performing handover, in case that it is determined that the CSG cell is the HPLMN, and in case that the mobile station device is set to measure the neighboring cell; and
not measuring the neighboring cell, in case that it is determined that the CSG cell is not the HPLMN, and even in case that the mobile station device is set to measure the neighboring cell.

2. The handover control method of the mobile station device according to claim 1, wherein the method not measuring the neighboring cell is performed so that a receiving level measurement unit in the mobile station device that measures the receiving level of the neighboring cell is stopped.

3. (canceled)

4. A handover control method of a base station device communicating with a mobile station device, the handover control method of the base station device comprising:
determining whether or not to permit handover, based on a handover refusal signal received from the mobile station device;
instructing a VPLMN so that the mobile station device executes a neighboring cell measurement, in case that it is determined to permit handover; and
instructing the VPLMN so that the mobile station device does not measure the neighboring cell, in case that it is determined not to permit handover.

5. The handover control method of the base station device according to claim 4, further comprising:
controlling the mobile station device so as to stop the neighboring cell measurement, in case that execution of the neighboring cell measurement is set in the mobile station device.

6. The handover control method of the base station device according to claim 4, wherein, in case that the execution of the neighboring cell measurement is not set in the mobile station device, the base station device does not transmit to the mobile station device a neighboring cell measurement instruction.

7. A mobile station device connected to a PLMN having a macrocell and a CSG cell, the mobile station device comprising:
a receiving signal level measurement unit configured to measure a cell in which the mobile station device is located and a neighboring cell;
a control data storage unit configured to set in which the measurement of the cell in which the mobile station device is located and the neighboring cell;
a handover determination unit configured to determine whether or not the mobile station device is within the service area of the CSG cell;
a cell determination unit configured to determine, in case that the handover determination unit determines that the mobile station device is within the service area, whether or not the CSG cell, in the service area of which the mobile station device is located, is an HPLMN; and
a handover refusal signal generation unit configured to generate a handover refusal signal, wherein,
in case that the CSG cell in which the mobile station device is located is the HPLMN, and in case that the control data storage unit is set so as to measure a neighboring cell, the neighboring cell measurement is executed and handover is performed, and
in case that the CSG cell in which the mobile station device is located is not the HPLMN, and even in case that the control data storage unit is set so as to measure a neighboring cell, the neighboring cell is not measured, or a handover refusal signal is generated.

8. A base station device communicating with a mobile station device, the base station device comprising:
a handover determination unit configured to determine, based on a handover refusal signal received from the mobile station device, whether or not to permit handover of the mobile station device;
a measurement execution control unit configured to control, based on the determination result of the handover determination unit, the execution of the neighboring cell measurement by the mobile station device; and
a control signal generation unit configured to generate a control signal that controls the mobile station device,
wherein the control signal generation unit is configured to generate, based on an instruction from the measurement execution control unit, a control signal that stops the neighboring cell measurement.
